(19) United States
(12) Patent Application Publication
(10) Pub. No.: US 2007/0179204 A1
(43) Pub. Date: Aug. 2, 2007

(54) Gel concentrate and method for increasing polymer load of a gel mineral oil without increasing viscosity beyond useful levels

(76) Inventors: Steluta Gina Butuc, The Woodlands, TX (US); David S. Morrison, The Woodlands, TX (US); Julie F. Thompson, The Woodlands, TX (US)

Correspondence Address: ARTHUR M DULA;LAW OFFICE OF ARTHUR M DULA, 3106 BEAUCHAMP STREET, HOUSTON, TX, 77009, US

(21) Appl. No.: 11/343,796

(22) Filed: Jan. 31, 2006

(51) Int. Cl. C08J 3/02

(52) U.S. Cl. 516/98

(57) ABSTRACT

This invention is a hydrocarbon gel concentrate containing a high polymer load and a polar compound. The method of the present invention allows for increasing polymer load of a mineral oil gel through the addition of a polar compound as a processing aid during gel formation such that the viscosity of the resulting hydrocarbon gel concentrate is mixable at processing temperature, thereby allowing dilution of the hydrocarbon gel concentrate with additional hydrocarbon oil.

### BACKGROUND OF THE INVENTION

Hydrocarbon oil gels containing loads of polymers greater than 10% are sometimes difficult to process due to their high viscosity at both room temperature and at higher processing temperatures. Many polar hydrocarbon gels are viscous at room temperature, but their viscosity often decreases with increased temperature.

In the prior art users of hydrocarbon gels have theretofore been required to ship the final gel product, which is bulky, heavy, and expensive. It would be useful to decrease the shipping costs by shipping a concentrated form of the hydrocarbon gel that contains a higher percentage of gellant polymers. This would be analogous to shipping concentrated fruit juice. However, a gelled hydrocarbon oil with a high load of polymers exhibits a very high viscosity that as a practical matter makes it difficult or even impossible to mix with hydrocarbon oil. It behaves as a stiff gel or a solid and therefore may not be conveniently or economically diluted with more hydrocarbon oil to a desired final gel.

In the present invention, the addition of a polar hydrocarbon, such as an alcohol, organic acid, amine or ester allows the gel to incorporate higher loads of polymers than a pure mineral oil gel while still having a viscosity low enough to permit mixing with hydrocarbon oil. This is a gel concentrate. Such a gel concentrate containing a polar organic material has a viscosity at processing temperature that is lower than a pure mineral oil gel.

### BRIEF SUMMARY OF THE INVENTION

This invention is a polar hydrocarbon composition with a high load of gellant polymers and a method for keeping the viscosity of the concentrated composition within an acceptable value for mixing and dilution of the concentrate with mineral oil to a desired concentration. An example of this would be a composition comprising about 0 to 99 wt % of one or more liquid aliphatic or alicyclic hydrocarbons; about 10 to 20 wt % of a gelling agent; and a third component comprising about 1 to 80 wt % of one or more polar hydrocarbons.

Upon dilution to a desired concentration, the polar compound may be subsequently removed from the oil and polymer mixture.

The concentrated composition of the present invention is processed, often at a temperature between 90° C. to 125° C. At such a processing temperature the viscosity of the concentrated gel of the present invention decreases sufficiently that the gelled concentrate may be mixed with hydrocarbon oil and thus may be further diluted to a desired final gellant concentration. The diluted hydrocarbon gel may then be further worked into a final product wherein the polar material may be selectively removed. The final product may also be cooled to a desired temperature.

### BRIEF DESCRIPTION OF THE FIGURES

FIG. 1 is a table showing the composition of the various embodiments of the concentrated gelled mineral oil compositions of the present invention. The individual components of the various compositions are shown in weight percent.

FIG. 2 is a table showing the composition of the various embodiments of the diluted gel mineral oil compositions taught by the present invention. The individual components of the various compositions are expressed in weight percent.

FIG. 3 is a table showing the viscosity of the gelled concentrate compositions taught by the present invention at a temperature of 25° C. and a processing temperature of 125° C. In addition the viscosity of the diluted counterparts of the gel concentrate compositions is shown at a temperature of 25° C.

FIG. 4 is a graph showing the viscosity of a preferred embodiment of the present invention over a range of temperatures. The invention is shown compared to a gelled ester and a gelled mineral oil containing no polar compounds.

### DETAILED DESCRIPTION OF THE INVENTION

This invention is a polar hydrocarbon composition with a high load of gellant polymers and a method for keeping the viscosity of the concentrated composition within an acceptable value for mixing and dilution of the concentrate with mineral oil to a desired concentration. Normally a hydrocarbon gel such as a mineral oil gel containing a high load of polymers is stiff and unable to be mixed. However, when a polar hydrocarbon, such as an ester or amine, is added during gel formation, the polar hydrocarbon decreases the viscosity of the concentrated gelled composition from an undilutable state to a viscous gel. Different polar groups exhibit differing levels of polarity, such that from most polar to least polar in descending order are:

1. Amide

2. Acid

3. Alcohol

4. Ketone

5. Aldehyde

6. Amine

7. Ester

8. Ether

9. Alkane

An effective amount of polar hydrocarbon will vary depending on both the size and shape of the hydrocarbon molecule as well as on the relative polarity of the polar group within the compound. In some embodiments for example, an effective amount of a polar compound ranges from 10 to 80 weight percent of the concentrated hydrocarbon gel. Upon subsequent heating to a processing temperature, defined as the temperature at which the hydrocarbon gel concentrate becomes less viscous, the hydrocarbon gel concentrate is diluted with additional liquid aliphatic or alicyclic hydrocarbons to a desired final concentration, and is then cooled to a lower temperature. Processing temperature for some embodiments is around 90° C. to 125° C., but this may vary depending on geographic location, barometric pressure, humidity, specific composition of the hydrocarbon gel, etc.

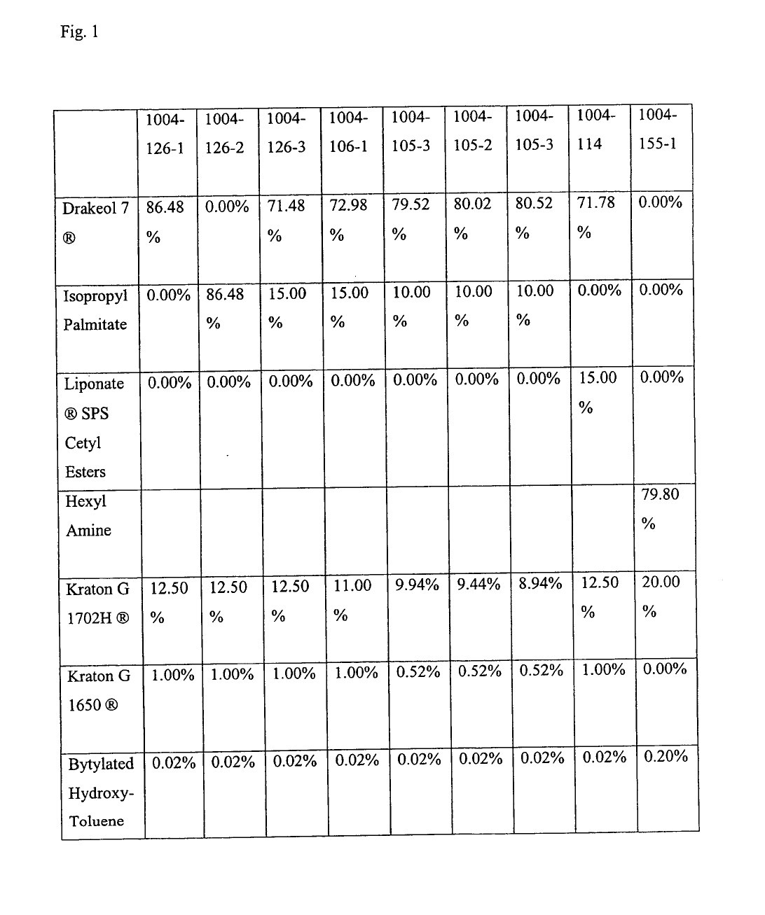

A preferred embodiment of the present invention is a method for allowing a high load of gellant polymers into a mineral oil gel while maintaining the viscosity of the concentrated gelled composition within useable limits of viscosity at a processing temperature of 125° C. is illustrated in composition 1004-126-3, shown in FIG. 1. In this composition, Drakeol 7® is a white mineral oil, the trademark of which is owned by Penreco Partnership. Isopropyl palmitate or Liponate® SPS are esters used as a polar processing aid. Liponate® SPS is a cetyl ester and is a registered trademark of Lipo Chemicals, Inc. Hexyl amine may also be used as a polar processing aid in some embodiments. Kraton G 1702H® and Kraton G 1650® are both styrenic block polymer gellants with a hydrogenated midblock. The Kraton® trademark is owned by Kraton Corporation. Butylated hydroxytoluene (BHT), is added as an antioxidant.

Viscosity was measured by the Brookfield viscosity method at a specific temperature using a Brookfield Viscometer to measure the torque required to stir the compound.

The effectiveness of the reduction in viscosity through the addition of isopropyl palmitate as a polar based ester is evident when the preferred embodiment 1004-126-3, FIG. 1, is compared with composition 1004-126-1, FIG. 1, a mineral oil gel not containing a polar base ester, and 1004-126-2, a gelled ester control also shown in FIG. 1.

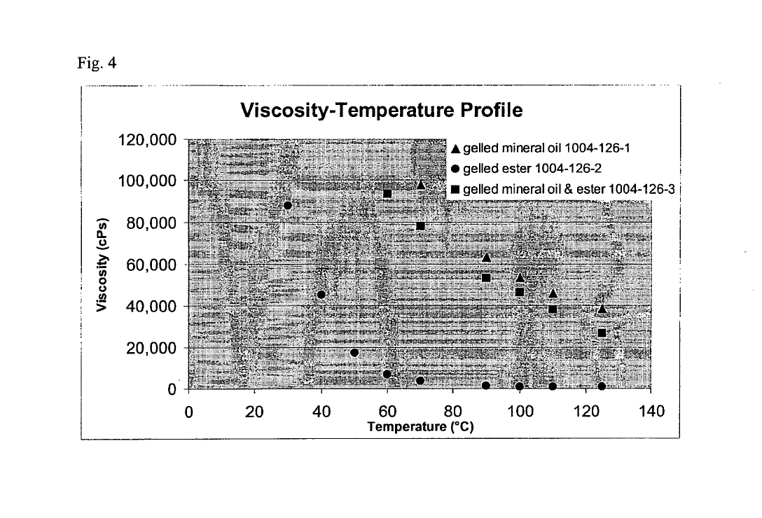

The table, FIG. 4, shows a comparison between composition 1004-126-1, FIG. 1, the mineral oil gel not containing a polar ester processing aid, continuously exhibiting a higher viscosity than does the preferred embodiment 1004-126-3, FIG. 1, over a range of temperatures. The gelled ester control, 1004-126-2 FIG. 1, exhibits a lower viscosity than both the gelled mineral oil 1004-126-1, FIG. 1, and the preferred embodiment 1004-126-3, FIG. 1, as shown in FIG. 4.

In FIG. 1, example 1004-126-3 has a polymer concentration of 13.50% of the weight of the composition and exhibits a viscosity of 619,000 cPs at 25° C. as shown in FIG. 3. When 1004-126-3 is increased to a processing temperature of 125° C., the viscosity of this sample is reduced to 26,700 cPs. as shown in FIG. 3.

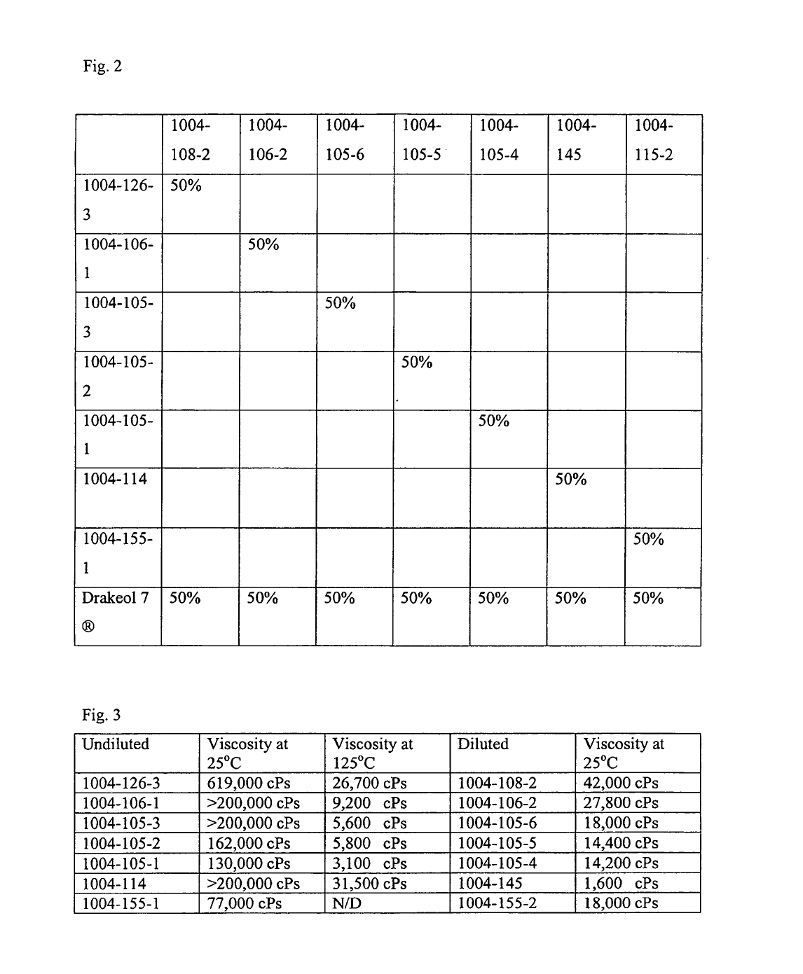

A preferred embodiment shown in example 1004-126-3 in FIG. 1, is then diluted one to one with Drakeol 7®. This dilution takes place at a processing temperature of 90° C. The diluted composition of 1004-126-3, is shown in FIG. 2 as 1004-108-2, and exhibits a viscosity of 42,000 cPs at 25° C. as shown in FIG. 3.

Another embodiment of the present invention is illustrated in composition 1004-106-1, shown in FIG. 1, which has a polymer concentration of 12.00% of the weight of the composition. This embodiment exhibits a viscosity of greater than 200,000 cPs at a room temperature of 25° C. When this embodiment is increased to a processing temperature of 125° C., the viscosity is reduced to 9,200 cPs as shown in FIG. 3.

This concentrated composition is then diluted one to one at a processing temperature of 125° C. with Drakeol 7®. When cooled to 25° C., the diluted composition, 1004-106-2 as shown in FIG. 2, exhibits a viscosity of 27,800 cPs as shown in FIG. 3.

Yet another embodiment of the present invention is illustrated in the composition 1004-105-3, shown in FIG. 1, in which in which the percentage of polymer is 10.46% of the weight of the composition. Prior to one to one dilution with Drakeol 7®, the compound has a viscosity of greater than 200,000 cPs at 25° C. as shown in FIG. 3. When this embodiment is increased to a processing temperature of 125° C., the viscosity is reduced to 15,600 cPs as shown in FIG. 3. After dilution, when cooled to 25° C., the composition, now labeled 1004-105-6, as shown in FIG. 2, has a viscosity of 18,000 cPs as shown in FIG. 3.

Another embodiment of the present invention is illustrated in the composition 1004-105-2 as shown in FIG. 1, in which the percentage of polymer is 9.96% of the weight of the composition. Prior to a one to one dilution with Drakeol 7®, the composition has a viscosity of 162,500 cPs at 25° C. as shown in FIG. 3. When this embodiment is increased to a processing temperature of 125° C., the viscosity is reduced to 5,800 cPs as shown in FIG. 3. After dilution the composition, now labeled 1004-105-5, as shown in FIG. 2, has a viscosity of 14,400 cPs at 25° C. as shown in FIG. 3.

Still another embodiment of the present invention is illustrated in composition 1004-105-1, FIG. 1, in which the percentage of polymer is 9.46% of the weight of the composition. Prior to a one to one dilution with Drakeol 7® this composition has a viscosity of 130,000 cPs at 25° C. as shown in FIG. 3. When this embodiment is increased to a processing temperature of 125° C., the viscosity is reduced to 3100 cPs as shown in FIG. 3. After dilution the composition, now labeled 1004-105-4, FIG. 2, has a viscosity of 14,200 cPs at 25° C. as shown in FIG. 3.

Still another embodiment of the present invention is illustrated in composition 1004-114, shown in FIG. 1, which is identical to composition 1004-126-3, also shown in FIG. 1, except that the polar ester isopropyl palmitate has been substituted for the cetyl ester Liponate® SPS. Prior to a one to one dilution with Drakeol 7®, the composition has a viscosity greater than 200,000 cPs at 25° C. as shown in FIG. 3. When this embodiment is increased to a processing temperature of 125° C., the viscosity is reduced to 32,500 cPs as shown in FIG. 3. After dilution, the composition, now labeled 1004-145, FIG. 2, has a viscosity of 31,600 cPs at 25° C. as shown in FIG. 3.

Another embodiment of the present invention is illustrated in compound 1004-155-1, shown in FIG. 1. Compound 1004-155-1 differs in composition from other previously mentioned embodiments as the polar material is hexyl amine rather than an ester. The percentage of polymer in this embodiment is higher than in previously mentioned embodiments at 20.00% of the composition. In this embodiment, composition 1004-155-1 contains 79.80% hexyl amine, 0.20% BHT, and 20.00% Kraton G 1702 polymer®. No white mineral oil is present. Prior to a one to one dilution with Draekol 7®, the composition has a viscosity of 77,000 cPs at 25° C. as shown in FIG. 3. After dilution, the composition, now labeled 1004-155-2, FIG. 2, has a viscosity of 18,000 cPs. at 25° C. as shown in FIG. 3. Unlike previous embodiments, the processing temperature of the present embodiment is 25° C.

Upon dilution to the desired concentration the polar materials may removed from the composition through any standard removal process such as vacuum evaporation or heating.

While there have been described what are believed to be the preferred embodiments of the invention, those skilled in the art will recognize that other and further changes may be made thereto without departing from the spirit of the invention. The invention is limited and defined by the appended claims and their equivalents.

1. A concentrated gelled composition comprising:
a first component comprising about 0 to 99 weight percent of one or more liquid hydrocarbons;
a second component comprising about 10 to 20 weight percent of one or more gelling agents;
and a third component comprising about 1 to 80 weight percent of one or more polar hydrocarbons.

2. The composition of claim 1, wherein the gelling agents are comprised of one or more polymers.

3. The composition of claim 2, wherein the polymers are composed of at least one styrenic block copolymer.

4. The composition of claim 3, wherein the styrenic block polymers are a combination of diblock and triblock copolymers.

5. The composition of claim 1 wherein the liquid hydrocarbons are aliphatic or alicyclic.

6. The composition of claim 5, wherein the liquid aliphatic or alicyclic hydrocarbons are mineral oil.

7. The composition of claim 1, wherein the one or more polar hydrocarbons are selected from a list of amides, acids, alcohols, keytones, aldehydes, amines, esters, ethers, and mixtures thereof.

8. The composition of claim 7, wherein the one or more polar hydrocarbons are selected from a list including isopropyl palmitate, cetyl ester, and hexyl amine.

9. The composition of claim 1, further including an antioxidant.

10. A method for reducing the viscosity of a gel containing a high concentration of gellant polymers, wherein a polar hydrocarbon is added to the gellant polymers and an effective amount of one or more liquid aliphatic or alicyclic hydrocarbons is added to allow further dilution with additional liquid aliphatic or alicyclic hydrocarbons to a desired final concentration.

11. The method of claim 10, including the step of adding additional liquid alicyclic or aliphatic hydrocarbons to the gel containing a high concentration of gellant polymers at an effective processing temperature.

12. The method of claim 11, wherein the preferred processing temperature is about 25° C. to 125° C., depending on environmental conditions and specific composition of the hydrocarbon gel.

13. The method of claim 12, including a means for removing the polar hydrocarbons from the desired final concentration.

14. A method comprising combining a hydrocarbon gel oil with at least one gellant, said gellant being in sufficient concentration that the resulting hydrocarbon gel would be too stiff to be mixable; and adding an effective amount of at least one polar component to the hydrocarbon oil and gellant while the gel is forming, whereby the resulting hydrocarbon gel concentrate is mixable at normal processing temperatures.
